(19) United States
(12) Patent Application Publication
(10) Pub. No.: US 2009/0151575 A1
(43) Pub. Date: Jun. 18, 2009

(54) ELEVATED ROTISSERIE FOR GRILL ASSEMBLY

(76) Inventor: Benjamin Cardozo Eisendrath, Washington, DC (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 11/957,218

(22) Filed: Dec. 14, 2007

(51) Int. Cl. A47J 37/04; A47J 37/07

(52) U.S. Cl. 99/340; 99/421 H

(57) ABSTRACT

A grill assembly comprising first and second rotisserie towers configured to be attached to opposing ends of a grill. The rotisserie towers are also preferably configured to support a rotisserie at a height to position rotisserie-cooked food over the surface of the grill. The grill is preferably configured to be vertically adjustable and preferably comprises a plurality of juice-catching channels configured to collect food juices from cooked food and deliver said juices to the front of the grill. Each rotisserie tower preferably comprising a rotisserie tower attachment structure detachably attached to said grill. Said grill assembly preferably further comprising a rotisserie rod configured to be rotationally supported on either side by respective first and second rotisserie towers.

### FIELD OF INVENTION

The invention relates to improvements in open flame cooking grills and rotisseries, preferably utilizing wood and charcoal fuel.

### BACKGROUND OF THE INVENTION

### 1. Prior Art

Iron framework grills for open flame outdoor cooking are known. One type has a bottom rack for supporting burning fuel, such as wood or charcoal, and has a vertically movable grill supported in the framework for movement up and down in the framework with the aid of a crank operated shaft. The grill comprises a plurality of parallel food supports, angled relative to horizontal, which serve as grease drains for the food supported on the grill. A rotisserie shaft can be used in the framework. One such grill is described in U.S. Pat. No. 4,462,306 to Eisendrath, incorporated herein by reference.

### SUMMARY OF THE INVENTION

In one aspect of the present invention, a grill assembly has a frame work support having a front side and a rear side. First and Second guide structures are also provided on said framework support and located between the front and rear sides. A horizontal support frame comprising a bracket at each end of the frame is also provided. Secured to said bracket is a movement structure configured to move said horizontal support frame to various vertical positions relative to a heat source. Supported on said horizontal support frame is a food support grill comprised of a plurality of juice-catching channels. An engagement structure is provided on each bracket, the engagement structure comprising an adjustment structure engageable with said guide structure to guide said support frame for vertical adjustment relative to said framework support. First and second rotisserie towers are disposed at opposing ends of the horizontal support frame and configured to support a rotisserie at a height to position rotisserie-cooked food over the surface of the food support grill. Each rotisserie tower comprising a rotisserie tower attachment structure configured to engage an attachment structure on said bracket to secure the rotisserie towers to said horizontal support frame.

In another aspect, the present invention relates to a grill assembly comprising first and second rotisserie towers configured to be attached to opposing ends of a grill. Said rotisserie towers also configured to support a rotisserie at a height to position rotisserie-cooked food over the surface of said grill. Said grill configured to be vertically adjustable and comprising a plurality of juice-catching channels configured to collect food juices from cooked food. Each rotisserie tower comprising a rotisserie tower attachment structure detachably attached to said grill. Said grill assembly further comprising a rotisserie rod configured to be rotationally supported on either side by respective first and second rotisserie towers.

In a further aspect, the present invention relates to a kit for a grill assembly comprising first and second rotisserie towers configured to be attached to opposing ends of a grill. Said rotisserie towers also configured to support a rotisserie at a height to position rotisserie-cooked food over the surface of said grill. Said grill configured to be vertically adjustable and comprising a plurality of juice-catching channels configured to collect food juices from cooked food. Each rotisserie tower comprising a rotisserie tower attachment structure configured to be detachably attached to said grill. Said grill assembly further comprising a rotisserie rod configured to be rotationally supported on either side by respective first and second rotisserie towers.

In yet another aspect, the present invention relates to a method for attaching a kit for a grill assembly comprising the steps of providing a grill configured to be vertically adjustable and comprising a plurality of juice-catching channels configured to collect the food juices from cooked food. Providing a rotisserie kit comprising first and second rotisserie towers configured to be attached at opposing ends of said grill. Each tower comprising a rotisserie tower attachment structure configured to attach to said grill. The rotisserie kit further comprising a rotisserie rod configured to be rotationally supported on either side by said first and second rotisserie towers. The first and second rotisserie towers are then attached to opposing ends of the grill using said rotisserie attachment structure. Finally, positioning said rotisserie rod so that it is rotationally supported on either end by said first and second rotisserie towers at a height to position rotisserie-cooked food over the surface of said grill.

Objects and features of the invention will be apparent in the following description and claims in which the invention is described together with details to enable a person skilled in the art to practice the invention.

### BRIEF DESCRIPTION OF THE DRAWINGS

DRAWINGS accompany the invention and the various views thereof may be briefly described as:

FIG. 1 is a perspective view of the grill with rotisserie towers in place;

FIG. 2 is a side view of the grill;

FIG. 3 is a front view of the grill on line 2-2 of FIG. 2;

FIG. 4 is a sectional view on line 3-3 of FIG. 2

FIG. 5 is a view partially in section, taken on line 4-4 of FIG. 3;

FIG. 6 is a section on line 5-5 of FIG. 5;

FIG. 7 is a perspective view of the horizontal support frame;

FIG. 8 is a sectional view from front to back of the support frame and food grill;

FIG. 9 is a fragmentary view showing the lift and slide mechanism;

FIG. 10 is a view of an ash drawer;

FIG. 11 is a view of a unique scraper for the grill;

FIG. 12 is a view of a rotisserie lock;

FIG. 13 is a view of a rotisserie tower positioned above the support structure;

FIG. 14 is a view of another rotisserie tower;

FIG. 15 is an exploded view of a rotisserie tower kit.

### DETAILED DESCRIPTION OF THE PRESENTLY PREFERRED EXEMPLARY EMBODIMENTS, AND THE MANNER AND PROCESS OF USING THEM

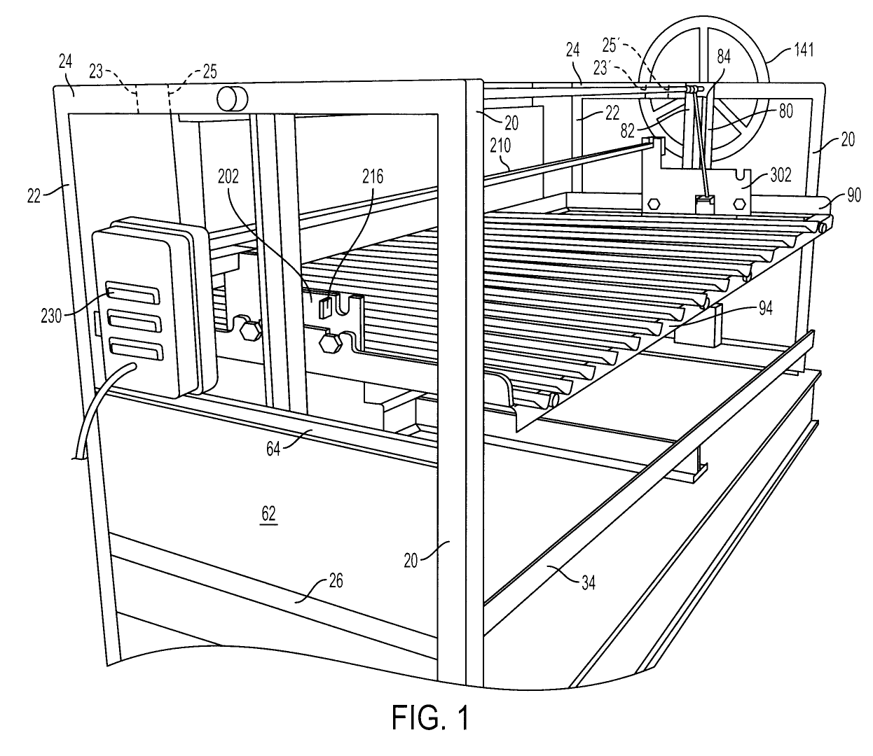

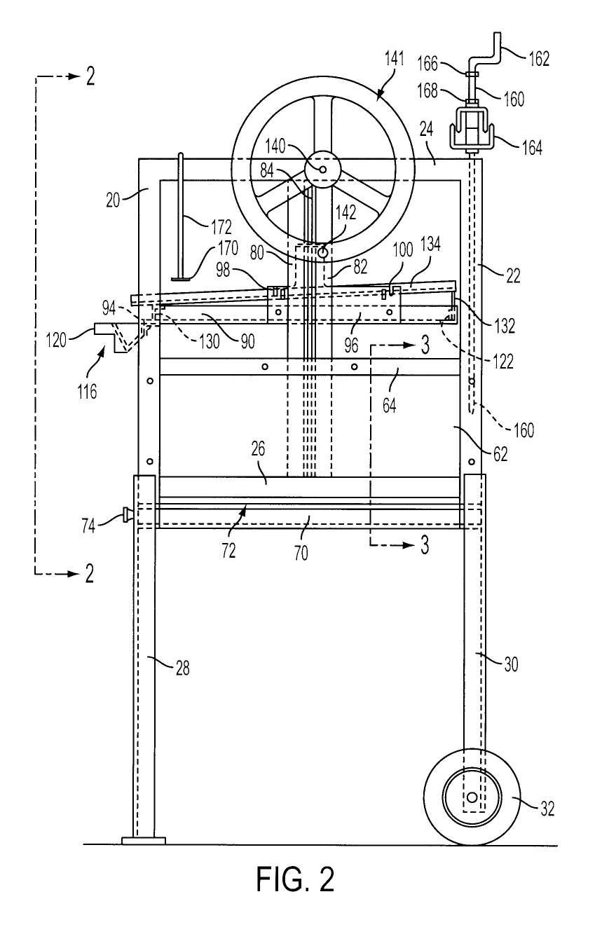

With reference to FIG. 1, a rectangular side frame having front and rear angles (preferably angle iron lengths) 20, 22 and top and bottom angles 24, 26 is supported by fore and aft legs 28, 30 (not shown) suitably affixed (e.g., bolted, screwed, or welded) to the frame. A similar side frame is disposed on the other side of the grill assembly and these two side frames are connected at the front by horizontal angle 34 at the bottom and at the rear by angles 36 (not shown in FIG. 1). Thus, the upper rectangular frames actually form a cubic enclosure that is open in front at the top. As shown in FIG. 2. the rear legs 30 preferably have a wheel 32 journalled at the bottom to facilitate moving of the grill.

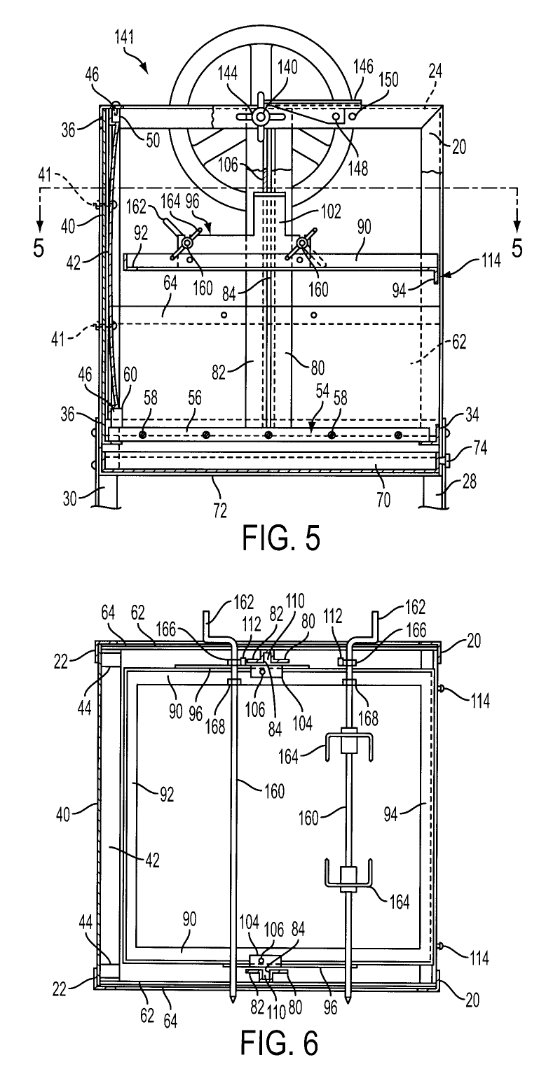

The rectangular frame at the rear of the unit, formed by uprights 22 and cross angles 36, is closed by a metal sheet 40 exposed at the back of the unit. See FIG. 5. An optional heat shield 42 can be mounted on sheet 40 and can be riveted in place along with sheet 40. The heat shield 42 is preferably made of 15 to 21 gauge, more preferably 16 to 20 gauge, even more preferably 17 to 19 gauge stainless steel, though any suitable size and metal can be used. This heat shield 42 has a flanged edge which is turned towards back sheet 40 and a side flange 46 which spaces the heat shield 42 outwardly from the back sheet about ¼ to ⅞ of an inch, preferably from ⅜ to ¾ of an inch, more preferably from ½ to ⅝ of an inch. This forms an air space which insulates the back sheet from direct heat of the heat source and thus prevents buckling of the back sheet. The heat shield 42 is preferably positioned vertically with the side flanges 46 disposed proximal to the top and bottom of sheet 40. However, the heat shield 42 can also be horizontally with the side flanges disposed proximal to uprights 22.

The heat shield 42, as shown in FIG. 5, has a concave curve. As illustrated in FIG. 5, this sheet is maintained in this curved position preferably by bolts 41. Bolts 41 preferably have a typical nut and bolt configuration, allowing them to pass through both the back sheet 40 and the heat shield 42, thus maintaining the curvature of heat shield 42 without being attached to either the back sheet 40 or the heat shield 42. This arrangement allows the heat shield 42 to expand and contract in response to changes in heat as will be described below. Alternatively, the curvature of the heat shield can be maintained by any means known in the art including, but not limited to, screws, rivets, or welding.

The curvature of heat shield 42, together with the flanged edges, allows the heat shield 42 to expand and contract without distorting the frame and also provides a deflector function reflecting the heat of the grill toward the center of the cubic enclosure. The curvature of heat shield 42 is also dependent on the amount of thermal expansion undergone by the heat shield material. Thermal expansion causes, as the temperature increases, the heat shield material to expand in all directions. As the heat shield 42 expands along its longitudinal axis, it will push outwardly at flanges 46 causing heat shield 42 to buckle slightly, effectively increasing the amount of curvature. The reverse is true as the temperature decreases. Thus, the amount of curvature of the heat shield 42 is dependent on the temperature radiating from the heat source in a direct relationship. Also, the amount of heat deflection from the heat shield 42 is dependent on the amount of curvature of the heat shield 42 and is therefore also heat dependent. The heat shield 42 can curve and additional ¼″ to 1″ in response to the heat.

A fire grate 54 formed of spaced steel strips 56 (FIG. 5) welded to suitable cross-strips 58, rests on the rectangular frame at the bottom of the cubic frame formed by angles 26, 34, 36. This fire grate is removable from the frame and has sufficient clearance that any expansion due to the heat to which it is subjected will not distort the frame.

Two deflector side plates 62, preferably of stainless steel, are disposed at the bottom of each of the side rectangles of the frame. A cross-strip 64 reinforces these plates at the top edge.

Below the supported grate 54 at each side of the unit are angles 70 turned inwardly to provide slides for a flat ash tray 72 shown in perspective in FIG. 10. The tray may be readily removed by handle 74.

It will be appreciated by those of skill in the art that the cubic frame with open front and top sides allows for optimal air flow characteristics. Air is drawn in from the bottom front of the cubic frame where it is heated by the heat source. The air then flows out the top back of the cubic frame. This convection current allows for various temperature zones in the cooking area from hottest at the back, where the hot air flows up to and out the top back of the cubic frame, to coolest at the front. Thus, foods that require substantially different cooking temperatures can be prepared substantially simultaneously. Already cooked food can also be kept warm towards the front of the grill.

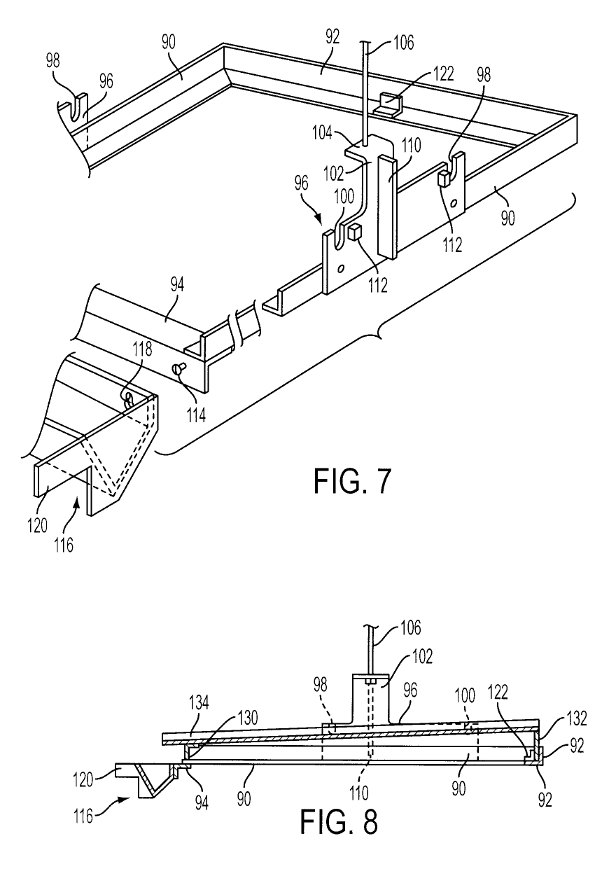

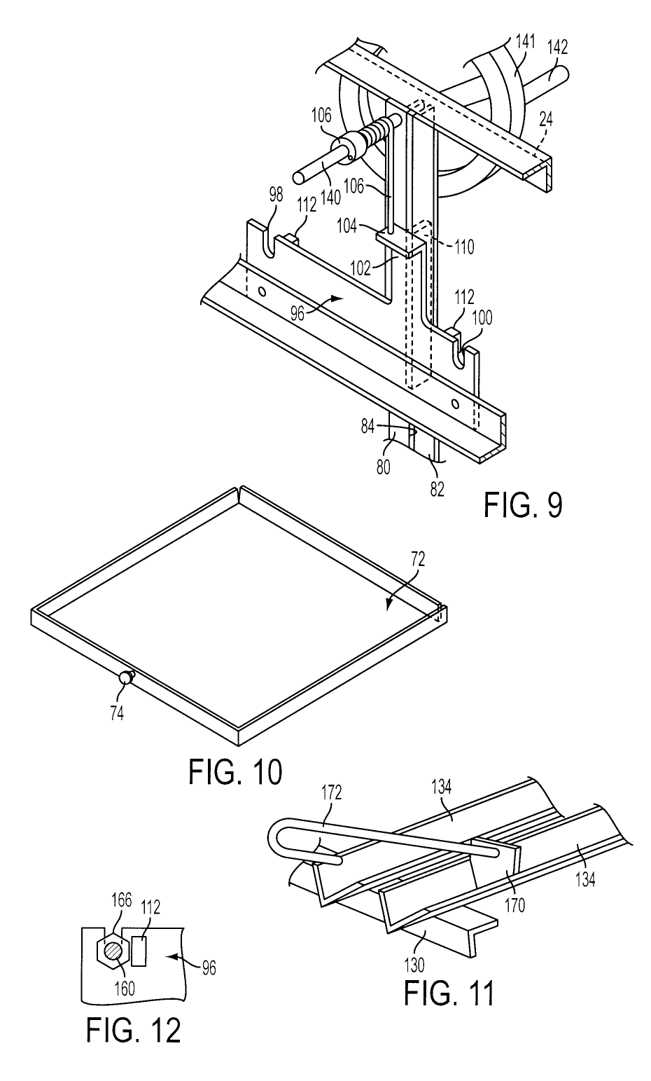

With reference to FIG. 6, on each side of the cubic frame, centrally and vertically disposed between upper and lower side frame members, are two angles 80, 82 spaced to form a vertical guide slot 84. Reference is now made to the fragmentary perspective view in FIG. 7 where there is shown a rectangular grill support frame with side members 90, a rear cross piece 92, and a front cross piece 94. The side and rear pieces are positioned as an upright L. The front piece 94 is inverted. On each side piece 90 a bracket 96 is riveted having a horizontal section extending above the side angles and notches 98 and 100 are located on either side of vertical angles 80 and 82. Alternatively, bracket 96 may be attached using any method known in the art, such as bolts, screws, welding, or bracket 96 may be formed integrally with side piece 90. A vertical extension 102 has an inwardly turned tab 104 to which can be fastened the end of a cable 106.

Extending outwardly from each bracket is a guide bar 110 dimensioned to have a sliding fit in guide slot 84. Lugs 112 can be welded adjacent notches 98 and 100 to serve as manual rotisserie locks, as will be explained below. Preferably headed rivets 114 are provided on the front flange of angle 94 to support a grease drip trough 116 (FIGS. 2, 3, 7 and 8). A back plate on the trough 116 has bayonet slots 118 which cooperate with rivets 114 to removably support the trough on front angle 94. Handle projections 120 serve to aid in the installation and removal of the trough. Of course, handle projections 120 can be any shape that allows easy handling of trough 116. Alternatively, handle projections 120 can be omitted in favor a lip or some other projection to facilitate installation and removal of trough 116. On the back angle 92 of the grill support frame is a securing piece 122 formed by two adjoining legs, one leg of which is welded to angle 92 and the other leg of which is spaced from the back run of angle 92. This leg serves as a positioner for a grill frame to be described.

The food grill, for supporting food to be cooked or warmed in the assembly, is shown in front elevation in FIG. 2, a sectional view on FIG. 8, and fragmentary perspective in FIG. 11. This food grill has a front cross angle bar 130, a rear cross plate 132, vertically disposed, and a plurality of grill bars 134 welded to the elements 130, 132. These grill bars are preferably formed of a high grade stainless steel, although any suitable material known in the art can be used. The grill bars are formed of any one of v-shaped, u-shaped, semicircular, or any other shape suitable for collecting and channeling a liquid in order to form juice-catching channels that catch juices released from the cooking food and direct said juices toward the front of the grill. The grill bars are angled downwardly from back to front because the back support plate 132 has a vertical dimension that is greater than that of front angle piece 130. Preferably, the angle of the food grill has a forward angle of about 0 to 10 degrees, more preferably 2 to 8 degrees, even more preferably, 3 to 6 degrees, and most preferably 4 to 5 degrees.

This food grill is supported on the grill support frame member 92 by the plate 132 at the rear which lodges behind the upstanding leg of securing piece 122. The front bar 130 of the food grill is supported on the front ends of side member 90 of the grill support frame. Since the grill support frame is always in a horizontal position, the food grill will always be in an angled position and the foreword ends of the grill bars 134 overlie the collection trough 116.

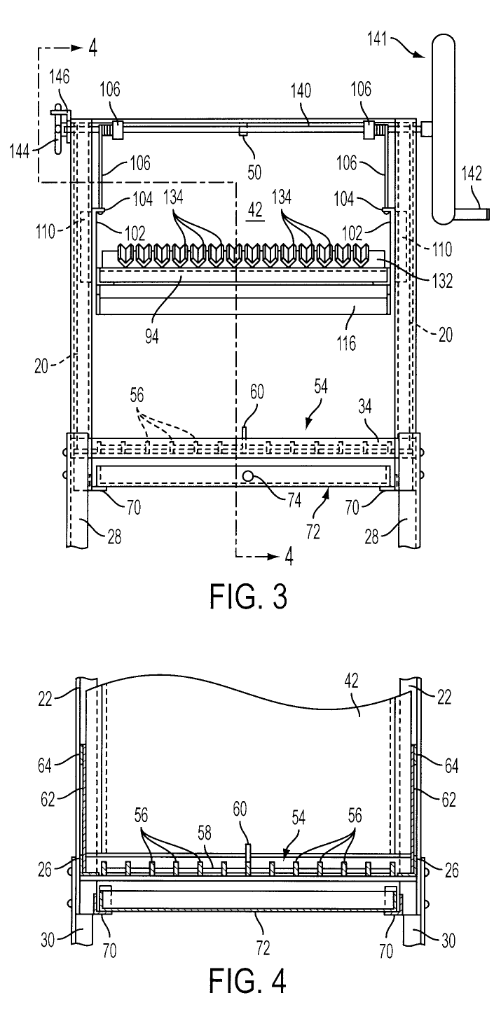

Cables 106 have been mentioned in connection with tabs 104 on the side brackets 96 of the grill support frame. As shown in FIGS. 3 and 10, the cables 106 extend up to a rotating shaft 140 journalled at the top of the spaced side plates 80, 82 and in cross frame members 24. The cable wraps around the shaft a sufficient number of turns to obtain the desired lower-and-raise range and are locked at one end by the rings 106. A cast wheel 141 weighing about 1 to 5 pounds, preferably about 2 to 4 pounds, more preferably about 3 pounds is mounted on one extending end of shaft 140 with an extending handle 142. The other end of the shaft 140 extends out of the frame to mount a ratchet wheel 144 which operates in conjunction with a lift ratchet 146 pivoted at 148. A stop pin 150 (FIG. 5) permits only limited release of the latch so it is always gravity actuated to a latching position. It may be manually lifted to a release position which will permit rotating of the wheel 141 and the shaft 140 in a direction to lower cables 106 and the grill support frame. Rotation of the wheel and shaft in the other direction will cause the ratchet wheel 144 intermittently to raise the latch as the frame is lifted to the position desired. The inertia of the cast wheel aids in the control of the grill support frame and food grill in the raising and lowering operation.

Thus, it will be seen that the grill support frame can be positioned in the proper position to support the food grill at a desired level from the heat source, which may be electric, hot coals, or fire built from wood, charcoal, gas, or any other suitable fuel, and the food may be cooked a prescribed time until ready for consumption. It will be appreciated that the vertical adjustability of the grill support frame affords greater control over the cooking conditions as compared to prior art grills when using fuels which cannot be easily adjusted.

It will be appreciated that the food grill is removable from the support frame. Manual rotisserie rods 160 can then be supported in the notches 98 and 100 of bracket 96 as shown in FIG. 6. The rods have crank handles 162 and suitable clutch pins 164 to engage the food whether it be a roast or a poultry unit. The manual rotisserie rods may be lifted and lowered with the support frame as previously described. The manual rotisserie rods preferably carry a multi-sided piece, such as a hexagonal nut 166, which may engage lug 112 (FIG. 12) to prevent rotation of the rod. When the manual rotisserie rod is moved axially so that nut 166 clears the lug, the rod can be turned. A second nut 168 is positioned to prevent the degree of movement of the rod which would dislodge the opposite end. The hexagonal nut allows the manual rotisserie rod to be locked rotatively in any of six different positions so that food may be progressively cooked as the rod is shifted from one rotative position to another.

In FIG. 11, a special scraper 170 with a handle 172 is illustrated. This scraper is shaped to fit the juice-catching channels of the food grill to assist in cleaning. Scraper 170, as well as the manual rotisserie rods 160, can be stored in the framework as shown in FIG. 2.

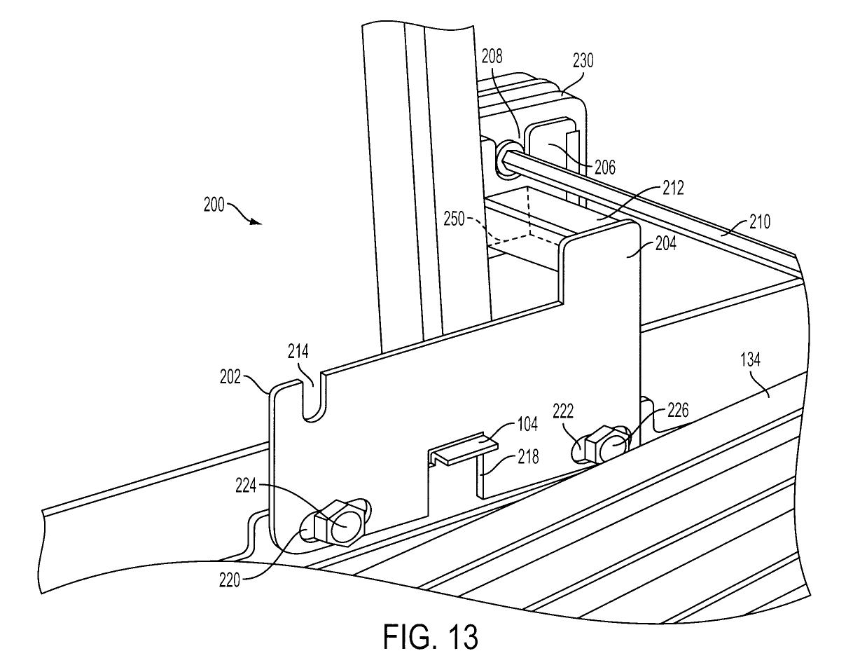

FIGS. 1, 13, 14, and 15 illustrate an alternate embodiment for a rotisserie system comprising of rotisserie towers 200 and 300. With reference to FIG. 13, rotisserie tower 200 comprises base plate 202 which has upward extending member 204 along one edge of base plate 202. A rotisserie rest 206 is disposed in a plane substantially parallel to that containing the base plate 202. Rotisserie rest 206 comprises a notch 208 configured to rotationally receive a rotisserie rod 210, similar to the notch 98 and the manual rotisserie rod 160 of the previous embodiment. Attached to and extending horizontally between upward extending member 204 and rotisserie rest 206 is connection member 212. Connection member 212 may have a cross section that is substantially u-shaped, inverted u-shaped, v-shaped, triangle, square, or any other shape that provides strength and rigidity. Base plate 202 further comprises notch 214 in its top edge opposite upward extending member 204. Notch 214 is configured to receive manual rotisserie rods 160 for operation as described above. Lug 216 (FIG. 1) is disposed next to notch 214 to perform substantially the same purpose as lug 112 described above. Base plate 202 further comprises notch 218 in the bottom edge which is configured to slidably engage tab 104 so that base plate 202 rests on bracket 96. Holes 220 and 222 align with notches 98 and 100 so that rotisserie tower 200 can be fastened to bracket 96 with bolts 224 and 226. As would be clear to one skilled in art, rotisserie towers 200 and 300 can be attached to brackets 96 by any means known in the art, such as bolts, screws, rivets, or welding. In another embodiment, rotisserie towers 200 and 300 are integral with brackets 96.

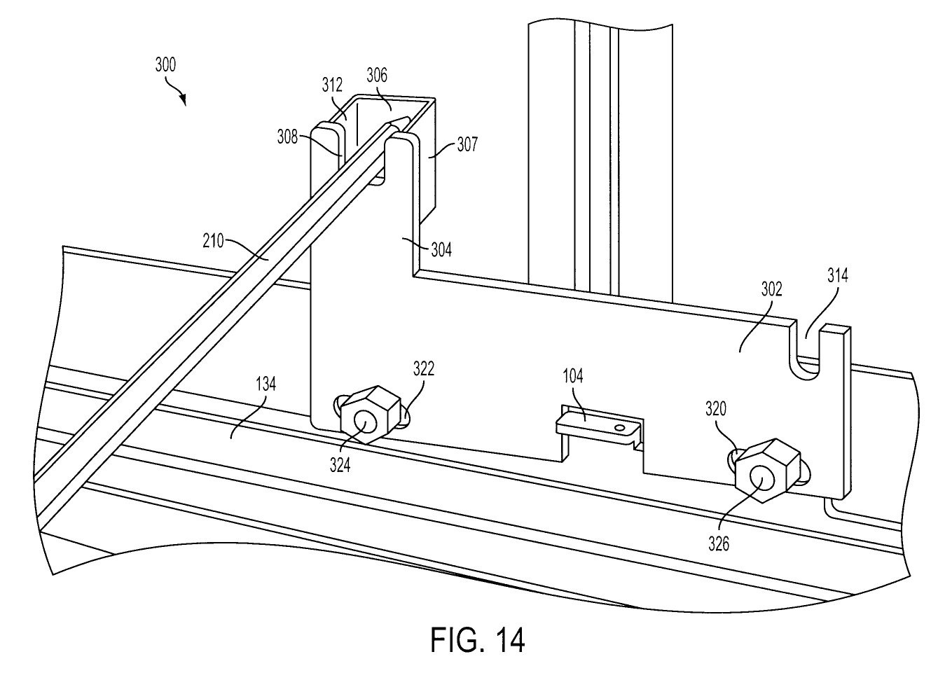

With reference to FIG. 14, second rotisserie tower 300 is configured to attach similarly to the opposing bracket 96. Rotisserie tower 300 comprising base plate 302 with upward extending member 304 extending upward from one side of base plate 302. Upward extending member 304 has notch 308 in the top edge thereof for receiving rotisserie rod 210. Stop piece 306 is provided to prevent the rotisserie rod 210 from sliding longitudinally while in operation. Attached to and extending horizontally between upward extending member 304 and stop piece 306 are connection members 312. Notch 314 is configured to receive manual rotisserie rods 160 for operation as described above.

It will be appreciated, with reference to FIG. 1, that a section of cross piece 24 between lines 23 and 25, 23′ and 25′ on the far side, can be removed to allow rotisserie rod 210 (supported by rotisserie towers 200 and 300) to rise above the level of cross piece 24, as the support frame 90 is raised to achieve the desired cooking conditions. Of course, lines 23 and 25, as well as 23′ and 25′, can be located to remove any size section of cross piece 24 up to and including removing the entire cross piece 24 from upright 22 to upright 82. Alternatively, the section of cross piece 24 between lines 23 and 25, and 23′ and 25′, can be removably or rotatably attached to the rest of cross piece 24 allowing it to be removed only when necessary to achieve the desired rotisserie height.

It will be appreciated by those of skill in the art that rotisserie towers 200 and 300 will support rotisserie rod 210 at a height so that the food grill can remain in place while food is cooked on the rotisserie. Thus, the juice-catching channels will collect the juices of the rotisserie-cooked food which can be used for basting or simply discarded. Also, since the food grill is still in place, it is possible to cook rotisserie food and regularly grilled food substantially simultaneously on separate areas of the grill.

Alternatively, a motor attachment 230 is provided. Motor attachment 230 comprises slot guides 231 configured to slidably engage rotisserie rest 206. Outwardly extending flanges 232 are provided at the bottom edge of rotisserie rest 206 to abut slot guides 231 and prevent further downward movement once the motor attachment 230 is in place. The motor attachment 230 may also comprise socket 235, which is configured to receive an end of rotisserie rod 210. Alternatively, to facilitate installation and removal of rotisserie rod 210 from socket 235 and rotisserie towers 200 and 300 in general, connection member 212 can be rotatably attached to rotisserie rest 206 along intersection 250 so that rotisserie rest can be rotated back (along with motor attachment 230 and rotisserie rod 210) until the opposite end of rotisserie rod 210 clears rotisserie tower 300. Motor attachment 230 is configured to rotate socket 235 in conjunction with rotisserie rod 210 at a suitable speed to cook rotisserie food evenly. Motor attachment 230 may be an electric motor or any kind of mechanical device including but not limited to fly-wheel, spring, or pendulum driven devices.

In another embodiment, motor attachment 230 is located underneath the grill assembly attached to bracket 96 by a downward extending structure. The motor attachment 230 can drive the rotisserie rod 210 by way of a chain, belt, shaft, or any other method known in the art which can extend upward from the motor 230 to the rotisserie rod 210, either inside the frame of the grill assembly along the downward extending structure, or outside the frame of the grill assembly. In this embodiment, the motor attachment 230 remains out of sight, leaving a clean look to the grill and keeping electrical cords (in the case of an electric motor) or mechanical devices out of sight, giving the cook access to the grill without such cords and devices getting in the way. Alternatively, a second motor 230 can be located underneath the grill assembly and attached to a second rotisserie rod 210 which can be supported by notches 214 and 314 so that twice as much food can be rotisserie-cooked and turned by said motors 230.

It will be appreciated that in one embodiment the cooking components that routinely need cleaning are removable and have dimensions that are preferably substantially less than or equal to about 40″, more preferably substantially less than or equal to about 30″, more preferably substantially less than or equal to about 25″, more preferably substantially less than or equal to about 15″, even more preferably substantially less than or equal to about 10″, and most preferably substantially less than or equal to about 20″ in order to fit in most standard sized dishwashers. This includes, but is not limited to, the food grill, the grease drip trough 116, the rotisserie rods 160 and 210, the fire grate 54, and the ash drawer 72.

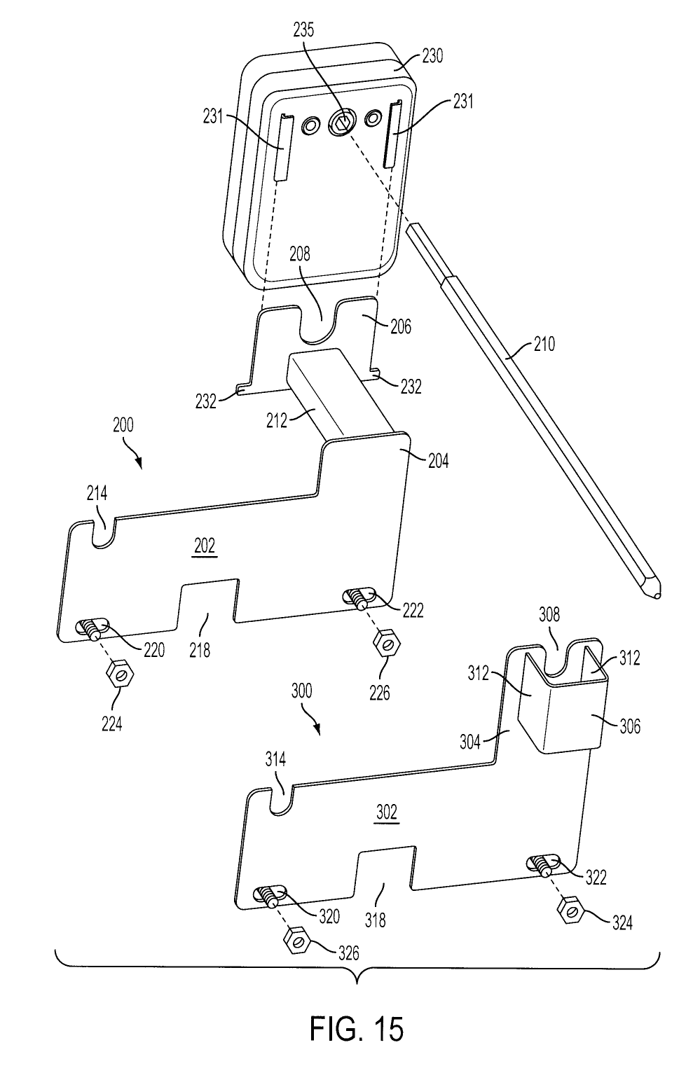

In another embodiment, with reference to FIG. 15 a kit for attaching a rotisserie to an existing grill is described. The kit could be sold in hardware stores, barbeque stores, over the Internet, or any other suitable store, and could either be assembled in the store or at home by the consumer. The kit comprises first and second rotisserie towers 200 and 300 described above, which are configured to be attached to opposing ends of a grill. The rotisserie towers also comprise rotisserie rod supports 206 and 306 which are configured to rotationally support a rotisserie rod 210 at opposing ends and at a height to position rotisserie-cooked food over the surface of said grill. The grill is configured to be vertically adjustable and comprises a plurality of juice-catching channels which are configured to collect food juices from cooked food, however, it will be appreciated that the kit can be adapted to attach to any existing grill assembly. Each tower comprises a rotisserie tower attachment structure configured to be detachably attachable to said grill.

In use, an operator of the grill assembly would attach the above described kit to a grill assembly by the following steps. The operator attaches the first and second rotisserie towers to opposing ends by placing the rotisserie attachment structure adjacent the grill and fastening the first and second rotisserie towers in place. In a preferred embodiment, similar to that shown in FIG. 13, the rotisserie attachment structure can be nut and bolt combination which engages holes or slots on the grill and is tightened to secure the rotisserie tower in place. Alternatively, clamps, screws, rivets, welding, or any other attachment method known in the art can be used to secure the rotisserie towers to the grill. The operator positions the rotisserie rod in the rotisserie rod supports so that it is rotationally supported on either end by said first and second rotisserie towers at a height to position rotisserie-cooked food over the surface of said grill.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A grill assembly comprising:
a framework support having a front side and a rear side;
a first and second guide structures on said framework support located between said front and rear sides;
a horizontal support frame comprising a bracket structure at each end of said frame;
a movement structure secured to said bracket structure and configured to move said horizontal support frame to various vertical positions relative to a heat source;
a food support grill comprised of a plurality of juice-catching channels supported on said horizontal support frame;
each said bracket structure comprising an engagement structure, said engagement structure comprising a adjustment structure engageable with the corresponding guide structure to guide said support frame for vertical adjustment relative to said framework support;
each said bracket structure further comprising an attachment structure;
first and second rotisserie towers disposed at opposing end of the horizontal support frame and configured to support a rotisserie rod at a height to position rotisserie-cooked food over the surface of the food support grill; and
each rotisserie tower comprising a rotisserie tower attachment structure configured to engage said attachment structure in the corresponding bracket structure to secure the rotisserie towers to said horizontal support frame.

2. The grill assembly according to claim 1, further comprising cooking components including rotisserie rods, a fire grate, an ash drawer, and grease drip troughs.

3. The grill assembly according to claim 2, wherein the cooking components are sized to fit in a standard dishwasher.

4. The grill assembly according to claim 1, wherein the food support grill is set at an angle between 3 and 6 degrees to horizontal.

5. The grill assembly according to claim 4, wherein the food support grill is set at an angle between 4 and 5 degrees to horizontal.

6. A kit for a grill assembly comprising:
first and second rotisserie towers configured to be attached at opposing ends of a grill and configured to support a rotisserie at a height to position rotisserie-cooked food over the surface of said grill;
said grill configured to be vertically adjustable and comprising a plurality of juice-catching channels configured to collect food juices from cooked food;
each tower comprising a rotisserie tower attachment structure configured to be detachably attachable to said grill; and
a rotisserie rod configured to be rotationally supported on either side by said first and second rotisserie towers.

7. The grill assembly according to claim 1, wherein the rear side of said grill assembly is closed by a flat sheet of metal and a heat shield is disposed on the inside of said outside sheet and coextensive vertically and horizontally with the cooking area, said heat shield being rearwardly flanged at top and bottom edges to space the edges of said heat shield forward of the outside sheet.

8. The grill assembly according to claim 7, wherein the heat shield is concave and configured to reflect heat to the cooking area.

9. The grill assembly according to claim 8, wherein the amount of curvature in the concave heat shield is heat dependent.

10. The grill assembly according to claim 9, wherein the heat shield's curvature is maintained by at lease one bolt, said bolt being configured to allow movement of said heat shield in response to heat.

11. A method for attaching a kit for a grill assembly comprising the steps of:
providing a grill configured to be vertically adjustable and comprising a plurality of juice-catching channels configured to collect the food juices from cooked food;
providing first and second rotisserie towers configured to be attached at opposing ends of said grill, each tower comprising a rotisserie tower attachment structure configured to attach to said grill, and a rotisserie rod configured to be rotationally supported on either side by said first and second rotisserie towers;
attaching said first and second rotisserie towers to opposing ends of the grill using said rotisserie attachment structure; and
positioning said rotisserie rod so that it is rotationally supported on either end by said first and second rotisserie towers at a height to position rotisserie-cooked food over the surface of said grill.

12. The method of claim 1, wherein food is cooked on said rotisserie while substantially simultaneously food is cooked on the grill surface.

13. A grill assembly comprising:
first and second rotisserie towers configured to be attached at opposing ends of a grill and configured to support a rotisserie at a height to position rotisserie-cooked food over the surface of said grill;
said grill configured to be vertically adjustable and comprising a plurality of juice-catching channels configured to collect food juices from cooked food;
each tower comprising a rotisserie tower attachment structure detachably attached to said grill; and
a rotisserie rod configured to be rotationally supported on either side by said first and second rotisserie towers.

14. The grill assembly according to claim 1, wherein at least one of said first or second rotisserie towers is configured to be rotatable in a plane containing said rotisserie rod in order to aid in installing or removing said rotisserie rod.

15. The grill assembly according to claim 6, wherein at least one of said first or second rotisserie towers is configured to be rotatable in a plane containing said rotisserie rod in order to aid in installing or removing said rotisserie rod.

16. The grill assembly according to claim 11, wherein at least one of said first or second rotisserie towers is configured to be rotatable in a plane containing said rotisserie rod in order to aid in installing or removing said rotisserie rod.

17. The grill assembly according to claim 13, wherein at least one of said first or second rotisserie towers is configured to be rotatable in a plane containing said rotisserie rod in order to aid in installing or removing said rotisserie rod.

18. The grill assembly according to claim 1, wherein at least one of said first or second rotisserie towers is configured to support a motor to turn said rotisserie rod.

19. The grill assembly according to claim 1, wherein a motor is provided under said grill assembly and configured to turn said rotisserie rod.

20. The grill assembly according to claim 3, wherein said grill assembly comprises a plurality of said dishwasher sized cooking components.

21. The grill assembly according to claim 1, wherein the juice-catching channels are configured to collect liquid and deliver it to the front of said grill.

22. The grill assembly according to claim 1, wherein at least a portion of said framework support is configured to be removable to facilitate movement of said horizontal support frame.
